(19) United States
(12) Patent Application Publication
(10) Pub. No.: US 2008/0237364 A1
(43) Pub. Date: Oct. 2, 2008

(54) Flux air cap and spray nozzle designs

(76) Inventors: Nitin Deshpande, Chandler, AZ (US); Harikrishnan Ramanan, Chandler, AZ (US); Ray Krick, Gilbert, AZ (US)

Correspondence Address: CAVEN & AGHEVLI;c/o INTELLEVATE, LLC, P.O. BOX 52050, MINNEAPOLIS, MN, 55402, US

(21) Appl. No.: 11/731,224

(22) Filed: Mar. 30, 2007

(51) Int. Cl. B05B 7/06

(52) U.S. Cl. 239/1; 239/424

(57) ABSTRACT

Methods and apparatus to improve flux air cap and/or spray nozzle designs are described. In one embodiment, a flux nozzle may include a cylindrical portion and a conical portion. Other embodiments are also described.

### BACKGROUND

The present disclosure generally relates to the field of electronics. More particularly, some embodiments of the invention generally relate to improved flux air cap and/or spray nozzle designs.

Flux may be used during the manufacturing process of integrated circuit devices to assist in soldering processes. In some implementations, flux may be sprayed over a substrate. However, non-uniform flux spray may result in critical issues such as spray paste related rework or touch-up. Addressing these issues may be time consuming and may further add to the costs associated with manufacturing an integrated circuit device.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates a view of flux spray flow in accordance with an embodiment of the invention.

FIG. 2 illustrates a block diagram of a flux spray system, according to an embodiment.

FIG. 3 illustrates a block diagram of a method according to an embodiment.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

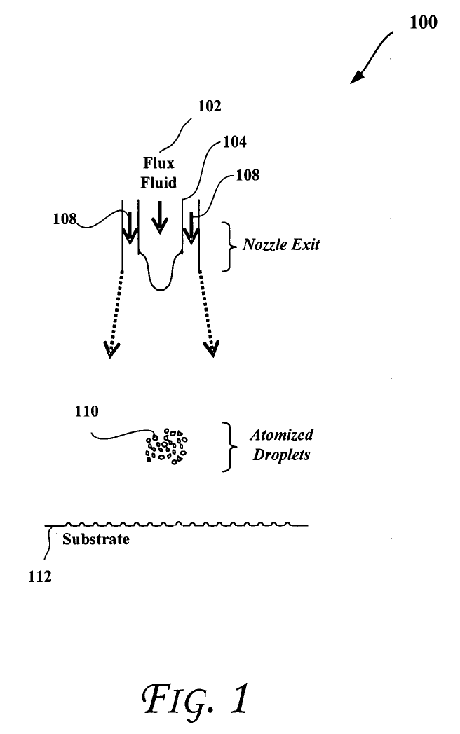

Some of the embodiments discussed herein (such as the embodiments discussed with reference to FIGS. 1-3) may utilize techniques to improve flux spray nozzle and/or air-cap designs, e.g., to provide a relatively more uniform air flow and/or longer air path length for improved flux spray atomization. More particularly, FIG. 1 illustrates a side view of a flux spray flow pattern development configuration, in accordance with an embodiment of the invention. As shown in FIG. 1, flux fluid 102 may be dispensed from a flux tube 104 (e.g., with assistance from a coaxial assist fluid 108 in an embodiment) through a sequential atomization process that may break the initial droplets (e.g., at the exit of the flux tube 104) into smaller atomized droplets 110 which subsequently are deposited on a substrate 112.

In an embodiment, the coaxial assist fluid 108 may be dispensed around the circumference of the flux tube 104. In some embodiments, the flux fluid 102 may include various materials that would be classified as soldering fluxes in semiconductor packaging technology. The flux tube 104 may be constructed with various types of material capable of transporting the flux fluid 102 such as metal or metal alloy, plastic or polymer, ceramic, etc. Moreover, the substrate 112 may be any type of a substrate such as a printed circuit board (PCB), organic or ceramic packages, and may include solder bumps to allow for connection of dies to the substrate 112.

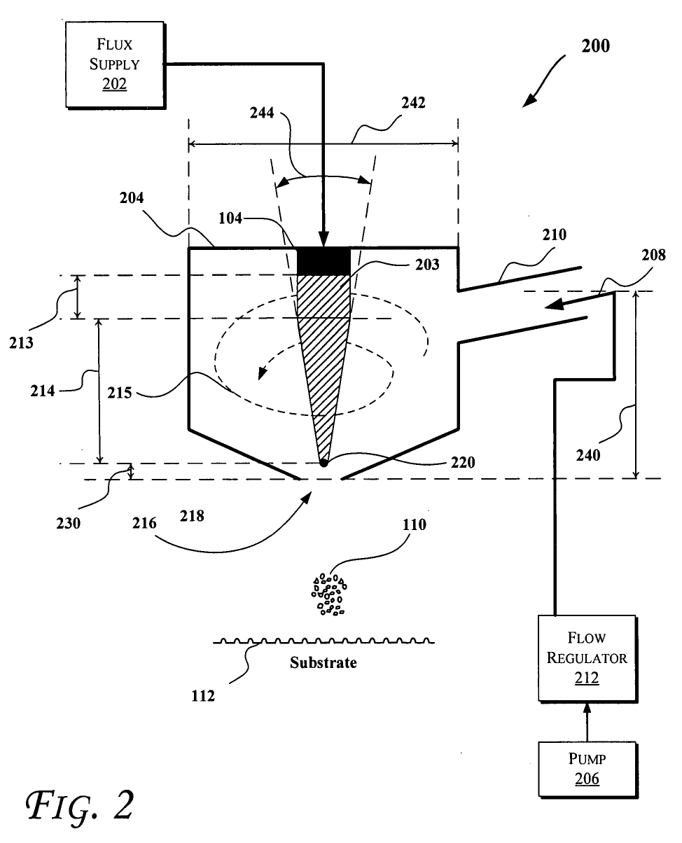

FIG. 2 illustrates a block diagram of a flux spray system 200, according to an embodiment. The system 200 may deliver the flux fluid through the flux tube 104 as the atomized droplets 110 that are deposited on the substrate 112, such as discussed with reference to FIG. 1. As shown in FIG. 2, the system 200 may include a flux supply 202 to supply the flux fluid. The flux tube 104 may be provided inside an air cap 204. Also, the flux tube 104 may be coupled to a nozzle 203. The air cap 204 may be coupled to an air pump 206 to receive a flow of a gas (e.g., flow 208), including an inert gas, such as air, nitrogen, mixtures thereof, etc., through an inlet 210. In an embodiment, a flow regulator 212 (such as an inline flow regulator) may be coupled between the pump 206 and the inlet 210 to regulate the flow of gases into the air cap 204.

In some embodiments, the inlet 210 may be provided tangentially relative to a vertical plane along the body of the air cap 204 (such as illustrated in FIG. 2, e.g., where the vertical plane is perpendicular to a plane that lies along a top surface of the air cap 204). Alternatively, the inlet may be provided at a level plane relative to the body of the air cap 204 (e.g., a plane that is perpendicular to the vertical plane along the body of the air cap 204, or parallel to a plane that lies along a top surface of the air cap 204). Furthermore, the flow 208 may enter the air cap 204 (tangentially or directly) at a cylindrical portion 213 of the nozzle 203. Alternatively, the flow 208 may enter the air cap 204 at a conical portion 214 of the nozzle 203.

As shown in FIG. 2, after entry into the air cap 204, the gas flow 208 may assume a swirling flow 215 configuration which is subsequently exhausted through an exit hole 216 at the bottom of the air cap 204 in FIG. 2. In an embodiment, the air cap 204 may have a select shape (such as a cylindrical shape) at least in portions that are in proximity to the flux tube 104 and the cylindrical portion 213 and/or the conical portion 214 of the nozzle 203, e.g., to cause the swirling flow 215. In an embodiment, the cylindrical portion 213 above the conical portion 214 may aid in increasing uniformity of the flow 214, e.g., due to a relatively longer path-length allowing stream-lined flow development. Moreover, in an embodiment, the flux tube 104 and/or nozzle 203 may be equidistance from the perimeter of the air cap 204, e.g., in the center of the air cap 204.

In an embodiment, the nozzle 203 may include one or more injection holes 220 to inject droplets (e.g., atomized droplets 110) towards the exit hole 216 for deposition onto the substrate 112. In one embodiment, the hole 220 may reduce the mean or average particle size in flux spray provided through the air cap exit hole 216. Furthermore, a prolonged contact of drops with the swirling coaxial flow 215 (e.g., within the region 230) may reduce the mean or average size of droplets 110. Accordingly, in one embodiment, a relatively uniform gas flow 215 provided prior to flux contact with the substrate 110 may result in more atomization of droplets 110. Additionally, stringers (e.g., elongated sheets of flux fluid) originating from nozzle tip and/or that spread on substrate 112 surface by the air flow dynamics post-impingement may be reduced or eliminated. Moreover, the stringers may be one of the main causes for overspray past the keep-out zone near or on the component pads when depositing flux onto the substrate 112. Accordingly, reducing or eliminating these stringers may reduce potentially critical issues such as spray paste related rework or touch-up, or clogging inside the air cap 204.

In some embodiment, the relative length of the cylindrical portion 213 and the conical portion 214 of the nozzle 203 may be adjusted to modify the air flow 215 for different implementations. For example, in one embodiment, the conical portion 214 of the nozzle 203 may be longer than the cylindrical portion 213 (such as illustrated in FIG. 2), e.g., to provide a relatively more direct radial entry of the gas flow 208 into the air cap 204. Alternatively, the conical portion 214 of the nozzle 203 may be shorter than the cylindrical portion 213, e.g., to provide a relatively more tangentional entry of the gas flow 208 into the air cap 204. Additionally, in one embodiment, the conical portion 214 may provide for gas flow control by limiting upstream pressure.

In one embodiment, the distances 240, 213, 214, 230, 242, and 245 may be respectively about 4.56 mm, 6.45 mm, 1.84 mm, 0.25 mm, 8.12 mm, and 8.29 mm. Also, angle 244 may be about 66 degrees. In another embodiment, the distances 240, 213, 214, 230, 242, and 245 may be respectively about 9.45 mm, 5.58 mm, 8.71 mm, 0.25 mm, 8.12 mm, and 14.29 mm. Also, in the latter embodiment, the angle 244 may be about 15 degrees. Alternatively, the distances 240, 213, 214, 230, 242, and 245 or angle 244 may be of any magnitude in various embodiments. Furthermore, in some embodiments, the angle between the conical portion 214 of the nozzle 203 and the vertical plane (e.g., a plane that is perpendicular to a plane that lies along a top surface of the air cap 204 of FIG. 2) may be varied, for example, the angle may be between about 2 and 10 degrees in accordance with some embodiments.

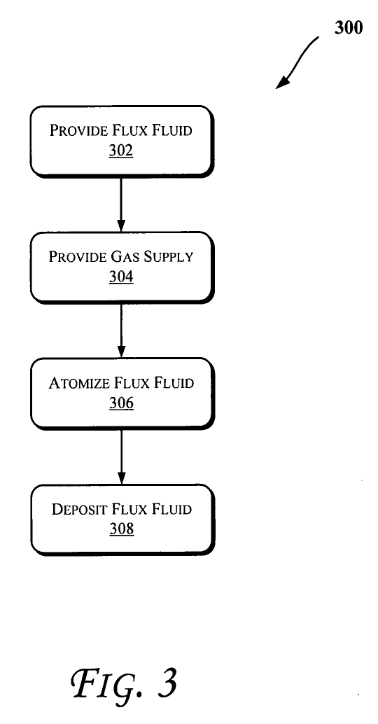

FIG. 3 illustrates a block diagram of an embodiment of a method 300 to improve flux spray splash control. In an embodiment, various components discussed with reference to FIGS. 1-2 may be utilized to perform one or more of the operations discussed with reference to FIG. 3. For example, the method 300 may be used to reduce flux overspray or splash and may further improve atomization of the droplets 110.

Referring to FIGS. 1-3, at an operation 302, flux fluid may be provided (e.g., by the flux supply 202). At an operation 304, gas may be supplied (e.g., gas flow 208 via the inlet 210). At an operation 306, flux fluid may be atomized, e.g., flux fluid 102 dispensed from the nozzle 203 into the flow 215 may be atomized. The atomized flux fluid may be deposited at an operation 308 (e.g., deposited onto the substrate 112).

Some embodiments may provide a relatively uniform air flow inside the air cap 204 before flux contact occurs for atomization. This may improve the atomization of droplets 110 and/or avoid stringer production. Furthermore, gas flow 208 through the inlet may be provided tangentially or radially (e.g., a different air cap for each option) and flow over a relatively longer path length. In an embodiment, the cone angle 244 may be altered, e.g., such that the flow 215 may be made narrower with respect to the tube 104 and/or nozzle 203. Additionally, as shown in FIG. 2, in accordance with at least one embodiment, the inlet 210 may be tilted slightly downward, e.g., to avoid potential gas flow in the upward direction inside the air cap 204.

In various embodiments of the invention, the operations discussed herein, e.g., with reference to FIGS. 1-3, may be implemented through hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include a storage device. For example, the operation of components of the system 200 of FIG. 2 may be controlled by such machine-readable medium.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection). Accordingly, herein, a carrier wave shall be regarded as comprising a machine-readable medium.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
a flux nozzle having a cylindrical portion and a conical portion; and
a flux tube coupled to the cylindrical portion of the nozzle,
wherein the conical portion of the nozzle is fluidly coupled to a gas flow provided inside an air cap that encompasses the nozzle.

2. The apparatus of claim 1, wherein the conical portion of the nozzle is to dispense the flux fluid onto a substrate through an exit hole of the air cap.

3. The apparatus of claim 1, wherein the flux fluid atomizes prior to deposition onto the substrate.

4. The apparatus of claim 1, further comprising a gas inlet coupled to the air cap to provide the gas flow.

5. The apparatus of claim 4, wherein the gas inlet is coupled to the air cap at a tangentional angle relative to a vertical plane intersecting the air cap.

6. The apparatus of claim 1, wherein the flux tube is equidistance from a perimeter of the air cap.

7. The apparatus of claim 1, further comprising a pump coupled to the air cap to provide a flow of an inert gas into the air cap.

8. The apparatus of claim 1, wherein the conical portion of the flux nozzle is longer than the cylindrical portion of the nozzle.

9. The apparatus of claim 1, wherein the conical portion of the nozzle is to dispense the flux fluid onto a substrate and wherein the substrate comprises a printed circuit board.

10. A method comprising:
fluidly coupling a conical portion of a flux nozzle to a gas flow provided inside an air cap; and
coupling a cylindrical portion of the flux nozzle to a flux tube to receive a flux fluid.

11. The method of claim 10, further comprising the conical portion of the nozzle dispensing the flux fluid onto a substrate through an exit hole of the air cap.

12. The method of claim 10, further comprising coupling a gas inlet to the air cap to provide the gas flow.

13. The method of claim 10, further comprising pumping a flow of an inert gas into the air cap.

14. The method of claim 10, wherein the conical portion of the flux nozzle is longer than the cylindrical portion of the nozzle.

15. The method of claim 10, wherein the flux tube is equidistance from a perimeter of the air cap.
